(19) United States
(12) Patent Application Publication
(10) Pub. No.: US 2009/0002556 A1
(43) Pub. Date: Jan. 1, 2009

(54) Method and Apparatus for Packet Insertion by Estimation

(75) Inventors: Sai Manapragada, San Jose, CA (US); Alvin Dale Kluesing, San Jose, CA (US)

Correspondence Address: GROOVER & Associates, BOX 802889, DALLAS, TX, 75380-2889, US

(73) Assignee: Picongen Wireless Inc., San Jose, CA (US)

(21) Appl. No.: 12/137,087

(22) Filed: Jun. 11, 2008

Related U.S. Application Data
(60) Provisional application No. 60/933,901, filed on Jun. 11, 2007.
(60) Provisional application No. 60/933,904, filed on Jun. 11, 2007.

(51) Int. Cl. H04N 5/14; G06F 15/16

(52) U.S. Cl. 348/575; 709/231; 348/E05.062

(57) ABSTRACT

A novel method, device and system for recovering missing data packets during data transmission. Data packets are tagged with corresponding frame index and packet indexes. Received data packets are buffered and plurality of frames are constructed. Missing data packets are identified either by packet indexing or by frame indexing or both. Corresponding missing pixels in a constructed frame are estimated by averaging surrounding pixels of current frame, selected previous frames and/or selected next frames. Missing pixels are replaced with the estimated values by inserting the created data packets of the pixel value back into the data stream.

### CROSS-REFERENCE TO OTHER APPLICATION

Priority is claimed from U.S. Provisional Application 60/933,904 and U.S. Provisional Application 60/933,901, both of which are filed on Jun. 11, 2007 and both of which are hereby incorporated by reference. This application may be related to the present application, or may merely have some drawings and/or disclosure in common.

### BACKGROUND

The present application relates to data transmission, and more particularly to data packet transmission and packet loss recovery. The content of the data packets includes, but not limited to, high-definition video, digital sound, satellite TV, cable TV, high speed data, games, etc.

Note that the points discussed below may reflect the hindsight gained from the disclosed inventions, and are not necessarily admitted to be prior art.

Various standards have emerged for the transport of digital data, such as digital television data. Examples of such standards include the Motion Picture Experts Group standard referred to as MPEG-2 sanctioned by the International Standards Organization (ISO) in Document ISO 13818. The MPEG coding technique uses a formal grammar (“syntax”) and a set of semantic rules for the construction of bitstreams to be transmitted. The syntax and semantic rules include provisions for multiplexing, clock recovery, synchronization and error resiliency. The MPEG is defined in the International Organization for Standardization, ISO/IEC 13818-1, International Standard, 13 Nov. 1994 entitled Generic Coding of Moving Pictures and Associated Audio: Systems, recommendation H.222.0, and ISO/IEC 13818-2, International Standard, 1995 entitled Generic Coding of Moving Pictures and Associated Audio: Video, recommendation H.262, both incorporated herein by reference. Multiplexing according to the MPEG-2 standard is accomplished by packaging raw elementary streams such as coded video and audio into packetized elementary stream (PES) packets which are then inserted into transport packets.

Although the MPEG-2 transport stream is designed with consideration for transmission in conditions that can generate data errors, lost packets may not be easily recovered through the protocol. Especially in wireless transmission.

Video/audio data transmission over IEEE 802.11 WLANs enables efficient distribution of live video or pre-recorded entertainment programs to many receivers simultaneously. However, digital video delivery requires high reliability, bounded delay and bandwidth efficiency. Wireless links are unreliable with time-varying and burst link errors. Specifically, in video multicast applications, different receivers of the same video may experience heterogeneous channel conditions. Receivers may also leave or join during the session so that the topology of network changes. Erroneous packets may be simply dropped. Packet loss can be detected by checking the sequence number field of the packet header. Therefore, it is important and a challenging task to support quality of services (QoS) for all the receivers of the multicast video in the desired serving area while efficiently utilizing the available WLAN resources.

### SUMMARY

The present application discloses new systems, devices and methods for packet loss recovery by insertion in data transmission.

In one embodiment, the Picon system is capable of using different compression routines to increase the capacity of the network.

In one embodiment, each frame is indexed and tagged to the packet. Each packet is indexed and tagged relative to the pixels it contains within the frame.

In data transmission, received data packets are analyzed, packets that are associated with a particular frame are identified and buffered, frame data for past N frames are stored in the memory for backward look-up and a delay of M frames is allowed to be stored in the memory for N-M frames of forward look-up; received packets are also analyzed to detect any missing packets using packet index.

In one embodiment, after a current frame is constructed, missing pixel data in a frame are identified using the combination of the frame index tags and/or packet index tags wherein the relative pixel position in a frame is therefore identified.

In another embodiment, the data for the missing pixel are then estimated using one or the combinations of: the pixels surrounding the missing pixel in the frame; the corresponding pixel in the previous frame(s) (backward look-up); the corresponding pixel in the next frame(s) (forward look-up); the pixels surrounding the corresponding pixel in the previous frame(s); the pixels surrounding the corresponding pixel in the next frame(s). For a cluster of missing pixels, estimation is done using one or a combination of (1) estimating first the outer-most pixel; (2) estimating first the pixel that is least missing in a series of frames. Estimated data packets are inserted back into the proper position of the index.

The estimation of missing pixel may be accomplished by averaging of backward look-up pixels and forward look-up pixels; averaging of surrounding pixels in the same frame; averaging of surrounding pixels in the previous (backward look-up) frame; averaging of surrounding pixels in the next (forward look-up) frame; averaging of surrounding pixels in the same frame and/or previous frame, and/or next frame.

In another embodiment, recovery of lost pixel packets includes replacing the missing pixel of a frame with the corresponding pixel in the previous or next frame; replacing a missing pixel of a frame with the average of the corresponding pixels from previous and next frame; replacing a missing pixel of a frame with the average of the pixels surrounding the corresponding pixel from previous frame and the corresponding pixel from the next frame; replacing a missing pixel of a frame with the average of the pixels surrounding the corresponding pixel from next frame and the corresponding pixel from the previous frame.

The disclosed innovations, in various embodiments, provide one or more of at least the following advantages:

Seamless integration with current data transportation protocols;

Simple, easy, practical and flexible data estimation with minimal overhead;

Broad application potential to different kinds of applications.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows an example data transmission network.

FIG. 2 shows an example of data processing in data transmission.

FIG. 3 shows an example multimedia wireless gateway.

FIG. 4 shows an example multimedia wireless receiver.

FIG. 5 shows a flowchart of an example data process containing packet recovery.

FIG. 6 shows an example of pixel estimation process in the process of packet recovery.

FIG. 7 shows another example of pixel estimation process in the process of packet recovery.

FIG. 8 shows another example of pixel estimation process in the process of packet recovery.

FIG. 9 shows another example of pixel estimation process in the process of packet recovery.

FIG. 10 depicts an example of pixel insertion in the process of packet recovery.

### DETAILED DESCRIPTION OF SAMPLE EMBODIMENTS

The numerous innovative teachings of the present application will be described with particular reference to presently preferred embodiments (by way of example, and not of limitation).

The Picon home network disclosed in this application is a wireless network comprising Picon Media Server and Picon Receiver that provides about 10× improvement in data throughput over standard Wi-Fi technology, thus enables consumers to stream high quality wireless video, digital audio and high speed data applications seamlessly and securely across multiple rooms in home and in office. It provides architecture to wirelessly transmit clock channels and information for encryption and decryption and other configurations, as well as packet recovery mechanisms.

A Picon system is compatible with existing wireless technology and High Definition Multimedia Interface (HDMI), IEEE 802.11, Multiple-in Multiple out (MIMO), standard Wi-Fi physical (PHY) and Media Access Control (MAC) layer, and existing IP protocols, extremely high bandwidth applications such as Voice IP (VOIP), streaming audio and video content (including high definition), multicast applications, and also supports convergent networks, ad hoc networks.

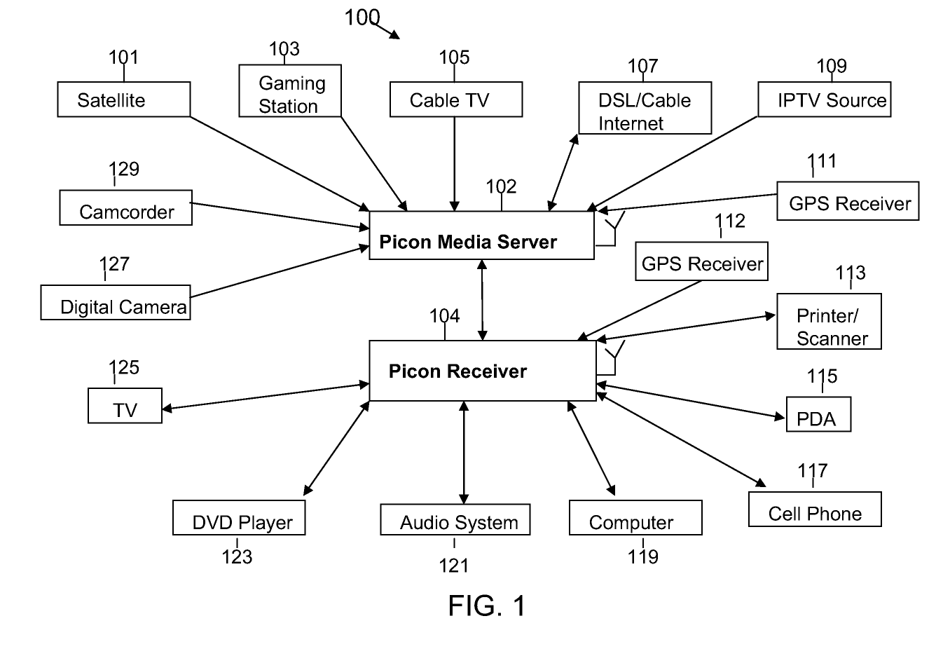

FIG. 1 is a network diagram illustrating an example wireless communication network 100 according to an embodiment of the present disclosure. In the illustrated embodiment, the wireless network 100 comprises a plurality of devices including device 111, 113, 115, 117, 119, 121, 123, 125, 127, 129 etc. Each of the devices can be any of a variety of multimedia and/or wireless devices, including a DVD player, digital audio systems, analog or digital TV, camcorder, digital camera, printer, scanner, fax machine, copy machine, graphics processor, cell phone, personal digital assistant (“PDA”), personal computer (“PC”), laptop computer, PC card, special purpose equipment, access point, router, switch, base station controller, game machine, Wi-Fi phone, security camera, set top box, GPS, or any combination of these and other devices configured to process and handle large amount of data.

With the aid of the Picon system, as shown in this embodiment, Picon media server 102 and receiver 104, these media display devices, regardless of whether they were originally capable of wireless communication, will gain the capacity to communicate to other devices in the network wirelessly. These devices become not only the data receivers, but also data providers, the communication can be configured to be bi-directional. Other data sources can, as indicated by such as 101, 103, 105, 107, 109, be any of a variety of cable TV, satellite system, gaming stations, broadband Internet, IPTVs etc provided by outside service providers, including audio, video data, or application data or the combination thereof. Depending on the service providers, the communication with these data sources can be configured to be bi-directional as well, that any of the above mentioned devices can send data to those service systems through the Picon media server/receiver wirelessly. The communication between the Picon media server and receiver is bi-directional.

High rate digital data come into the network through wire or satellite dish, via conventional connections such as satellite set-top box 101, gaming stations 103, cable TV set-top box 105, DSL modem 107, IPTV set-top box 109 etc. The high rate digital data are transmitted to Picon Media Server 102 through wire for data processing into lower rate digital data stream. Processed data are then wirelessly transmitted to Picon Receiver 104 which is connected with individual display devices 111, 113, 115, 117, 119, 121, 123, 125, 127, 129. Picon Receiver 104, upon receiving the wirelessly transmitted lower rate data stream, recovers and restores the lower rate data streams into the original high rate data stream and then transmits it to the respective corresponding display device. The wireless transmission may be based on Wi-Fi protocol (IEEE 802.11 or other protocol transmission protocols, such as 3G Code Division Multiple Access (CDMA) technologies, using IP and IP secure protocols.

In the illustrated embodiment, the network 100 could be any of a variety of network types and topologies and employ any of a variety of types of protocols. For the sake of providing a straightforward description, the illustrated embodiment will be described as an IEEE 802.11.

In between the data processing layer and the PHY layer, a data link layer Picon Air Interface (PAInt) may be included that acts an interface between the data processing layer and the PHY layer, which can be implemented in accordance with the Layer 3 of IP or MAC as specified in OSI seven layer model, to provide an addressing mechanism for identifying the physical address of the destinations of the data streams. The physical address may be a unique serial number assigned to each of the node devices on the network that makes it possible to deliver data packets to a destination within the network.

The PHY layer communicates with the MAC layer and with a radio frequency (RF) module. In certain embodiments, the MAC layer can include a packetization module (not shown). The PHY/MAC layers of the transmitter in the Picon media server add PHY and MAC headers to packets and transmit the packets to the Picon receiver over one or multiple wireless channels.

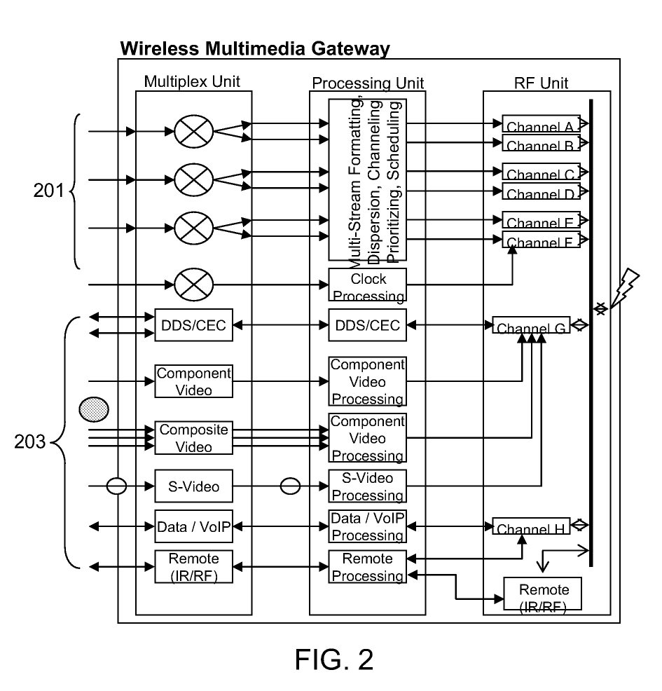

The PHY layer of a Picon transmitter includes one or more Wireless Multimedia Gateways (FIG. 2) may comprise both multi-streaming and multi-channelling mechanisms. Multi-streaming mechanism comprises plurality of parallel Wi-Fi like multiplexing units (201) which splits a single datastream into plurality of low rate (LR) bitstreams and distributes them among plurality of channels. The splitting of the original high rate data stream, for example of a high definition video, can be implemented using the Multiple-input and multiple-output (MIMO) technology as specified in IEEE 802.11n. For multi-channeling mechanism, each data type is processed in specific processing units (203), such as the DDC/CEC processing, composite video processing, component video processing, S-video processing, data/VoIP processing, etc.; and each of the sub-streams can be further processed in parallel in a processing unit that formats the sub-streams into packets with header information for the receiver(s) and be transmitted through one or more antennas in parallel. The number of antennas and the use of a specific antenna may be dynamically controlled by a controlling module that disperses, prioritizes, and schedules the transmission of each sub-stream.

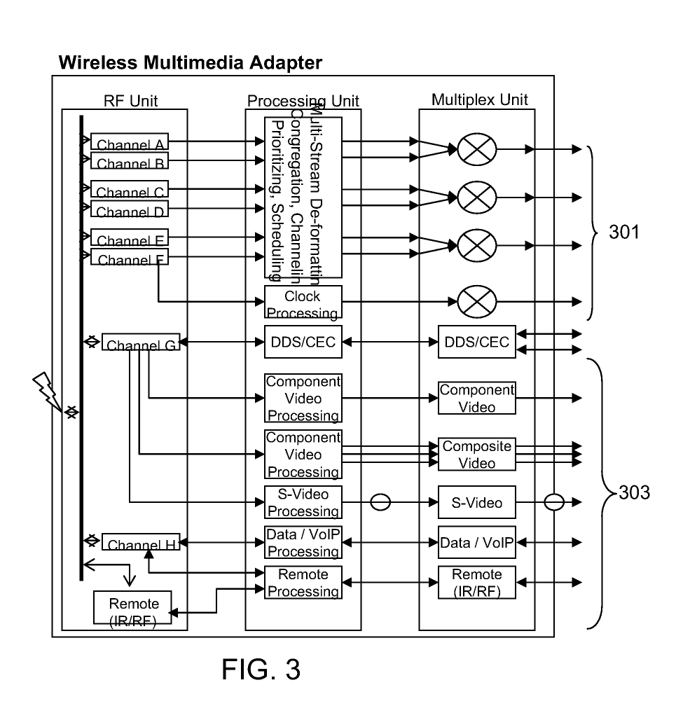

The PHY layer of a Picon receiver includes one or more Wireless Multimedia Adapters (FIG. 3) may comprise multiple parallel Wi-Fi adapter-like units (301) which can further have more than two low-rate receiving channels, each of which are linked to one or multiple antennas. Each of the received sub-streams of packets is further processed in a processing unit that de-formats the packets and checks for errors based on the header information. Such sub-streams of packets, depending the required criteria, may be further congregated in a multiplex converter to be outputted at high data rate, or can be outputted to the sink at a modified or a similar or the same data rate as that of the original data streams. Other received data streams may be processed according to their data types and sent to the specified destination displayer (403).

The Pico receiver can connect to devices using various external or internal interconnects such as PCI, miniPCI, USB, Cardbus and PC Card, or cable or digital TV connectors. The output data of a Picon receiver can be directly sent to a display device. For the signals that are originally analog, the output digital data may first be converted into analog signal by a digital to analog converter before sending to a display device.

In order to guarantee Quality of Service, the system may include packet loss prevention and packet recovery mechanism. A control module may be added to determine the route of processing for each type of datastreams. The control module may decide based on the data types, for example, for uncompressed & unencrypted datastreams, the input data may be compressed and transceived over the multi-channeling mechanism, both packet loss prevention and packet recovery may be necessary while for uncompressed but encrypted data types, multi-streaming mechanisms may be used and packet recovery may not be necessary. The control module may also decide based on the detection of loss of data packets, if loss of data packets are detected, packet recovery mechanism may be initiated.

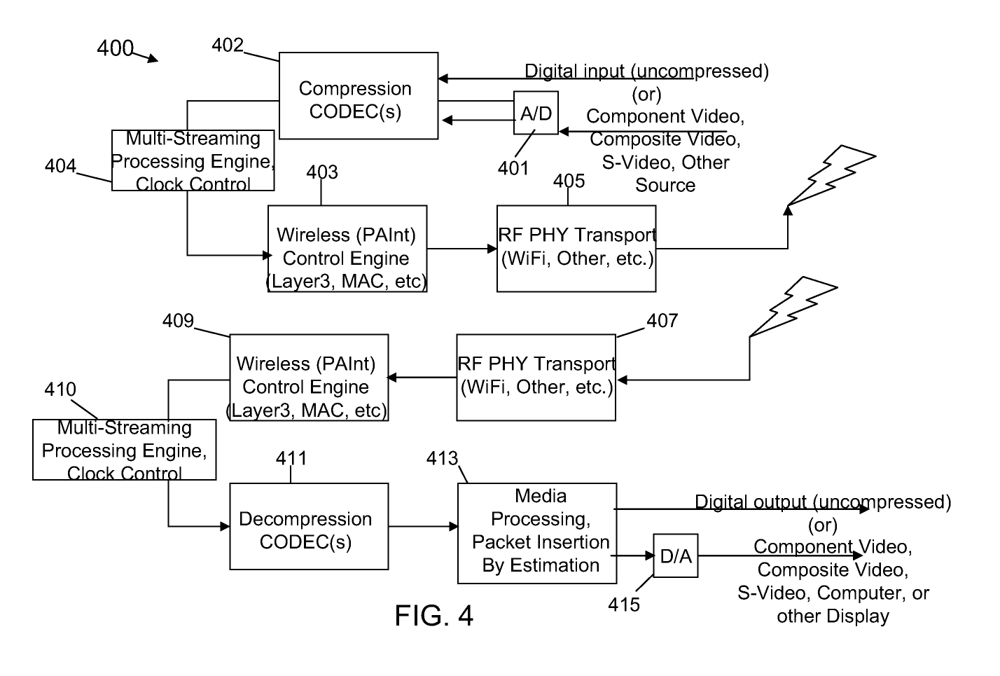

For example, in FIG. 4, the control module decides that the input data stream is uncompressed and unencrypted, the datastream may be first sent to Coder/Decoder unit 402 for encoding and compression. After compression, the datastream can be transmitted in sufficiently low data-rate stream. The control module may also direct the uncompressed and unencrypted data stream to the proper processing module 404 for packetization and multistreaming splitting which repacks the data stream into packets of different sizes forming a low data rate packet stream. After being processed for transmitting, the properly packed packets are transmitted via application layer and PHY layer 403 and 405.

The Picon receiver receives the wireless transmitted digital signals (407, 409) from the transmitter and conducts the reverse-processing to decode and reconstruct the signals back (410, 411) to the original format of the signals or according to the configuration. Because of the compression/de-compression processing, a further procedure of packet recovery is performed by using signal estimation insertion methods (413). And if the original data type is of analog signals, signals may be pre-processed with A/D converter (401) and post-processed with D/A converter (415).

The transmission and receiving of the wireless signals may also be controlled by the control module which dynamically allocates channels based on performance statistics. In one embodiment, it monitors and analyzes the performance of each channel and allocates the channels dynamically based on their performances as well as the configuration criteria at both transmitting and receiving ends. For example, if one of the channels shows degradation in performance, that channel will be replaced with a more robust channel to avoid further packet losses. This way, the packets are first stored in a frame buffer and they are scheduled and classified dynamically before they are transmitted. The receiver control module also periodically reports the statistics of the frames and packets using the tag information in the packets. This periodic reporting may occur for the past configurable N number of packets or frames, but may not report for each packet, thus drastically reduces the overhead and bandwidth usage due to reduced number of acknowledgements comparing to TCP/IP protocol.

Transition Minimized Differential Signaling (TMDS) protocol can be used for signal integration and congregation of the packets. In TMDS, video, audio, and control data are carried as a series of 24-bit words on three TMDS data channels with a separate TMDS channel for carrying clock information. Additionally, DVI/HDMI systems may include a separate bi-directional channel known as the Display Data Channel (DDC) for exchanging configuration and status information between a source and a sink, including information needed in support of High-Bandwidth Digital Content Protection (HDCP) encryption and decryption. In HDMI, an optional Consumer Electronic Control (CEC) protocol provides high-level control functions between audiovisual products.

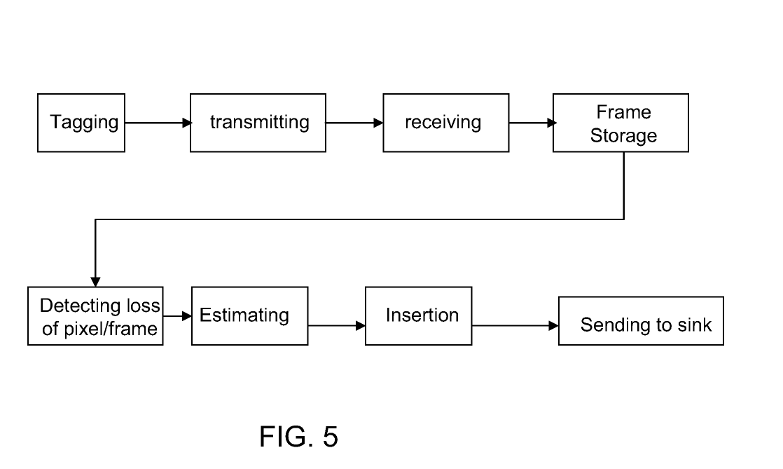

FIG. 5 shows a general data transmission process involved in packet recovery processes. First each transmitted frame is assigned a frame index which will be tagged to the packet to be transmitted; each packet is tagged with a packet index relative to the pixels it contains within the frame before transmitting. Frames are then transmitted. Received datastreams and frames are reconstructed and frame data for past N frames are stored in the memory for backward look-up; current frame is selected with a delay of M frames to allow for N-M frames of forward look-up frame memory.

Received packets are analyzed to find packets that are associated with a particular frame; received packets are also analyzed to detect any missing packets with reference to the packet index. After decoding the received packets, missing packets in a frame are identified; and missing pixel data in a frame is identified using one or a combination of: 1) frame index tags; 2) packet index tags, and relative pixel position of a missing pixel in a frame is also identified.

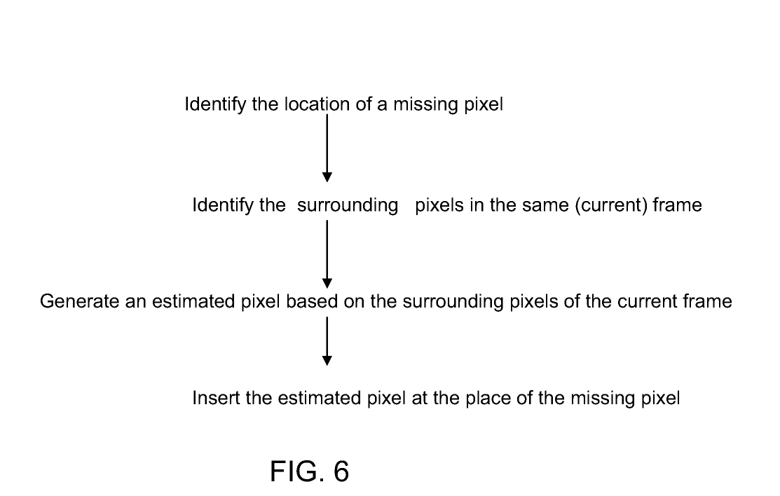

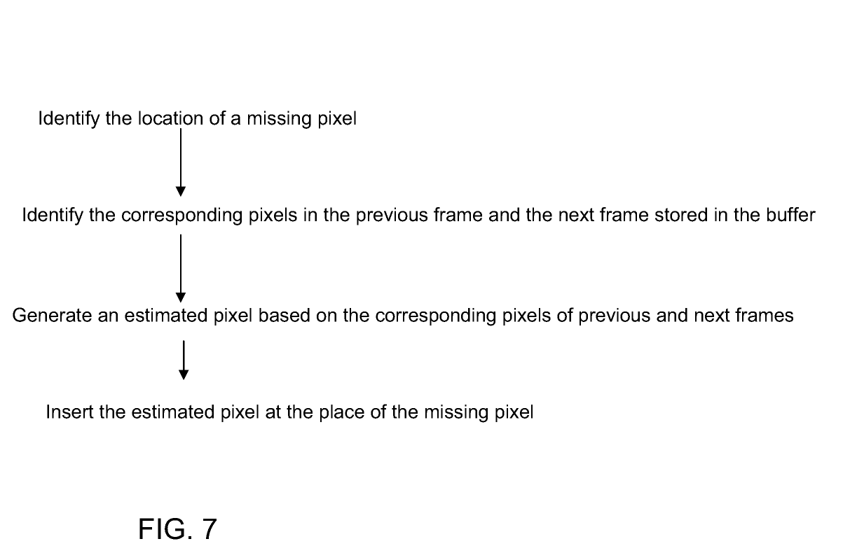

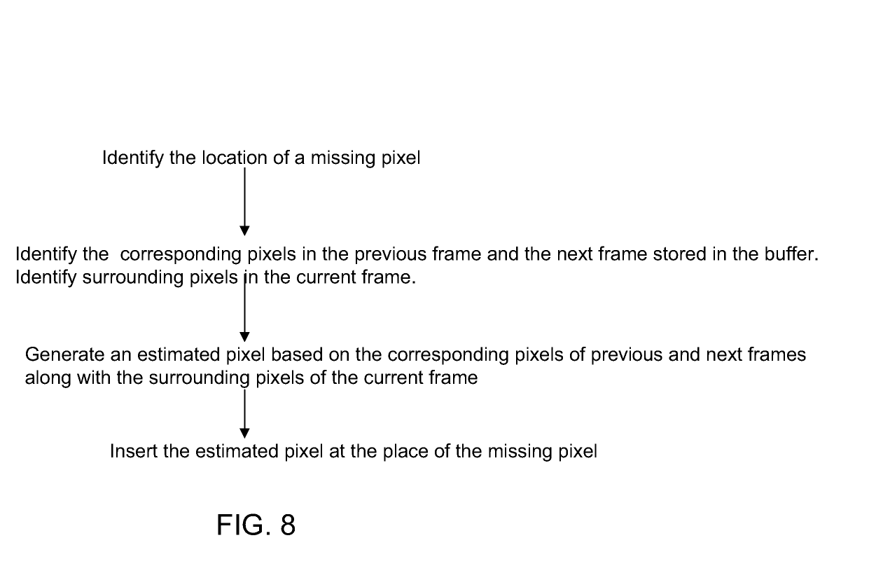

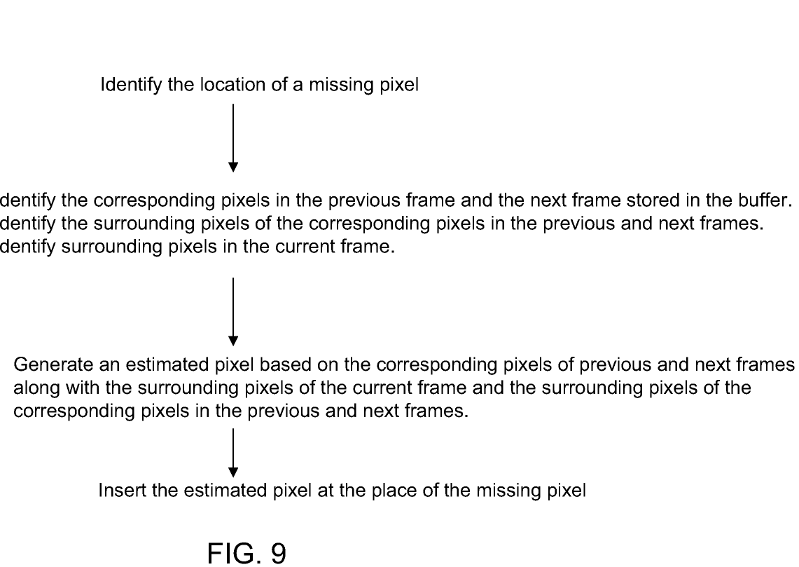

FIGS. 6-9 show methods of using different reference pixels for the estimation of a missing pixel based on the relative pixel position. The data for the missing pixel is estimated by approximating the values of the following pixels or the average of the combinations of a selected groups of the following pixels:

The pixels surrounding the missing pixel in the frame;

The corresponding pixel in the previous frame(s) (backward look-up);

The corresponding pixel in the next frame(s) (forward look-up);

The pixels surrounding the corresponding pixel in the previous frame(s);

The pixels surrounding the corresponding pixel in the next frame(s).

For a cluster of missing pixels, estimation is done by doing one or a combination of the following:

Estimating first the outer-most pixel;

Estimating first the pixel that is least missing in a series of frames.

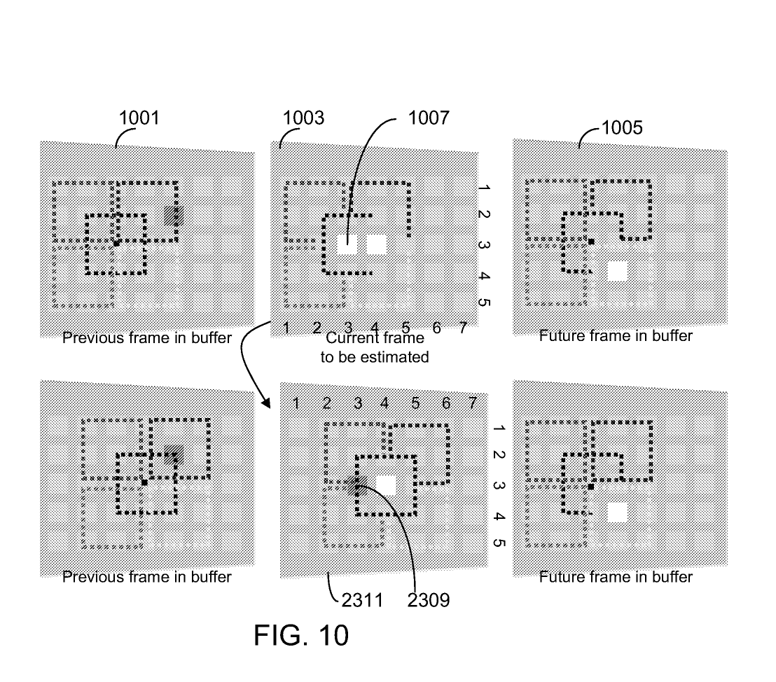

FIG. 10 shows an example of estimation of missing pixel 1007 by doing the following:

1). Estimating pixel 1007 using the data from pixels shown in dotted lines and dots from the current frame 1003 and from the previous frame(s) 1001 and pixels of the future frame(s) 1005 with lost data omitted as inputs in the estimation.

2). Estimating pixel 1007 using the data from pixels shown in dotted lines and dots from the current frame 1003 and from the previous frame(s) 1001 and the future frame(s) 1005.

The missing pixel can be calculated as the result of the following actions or the combinations of the following actions:

1) averaging of backward look-up pixel and forward look-up pixels

2) averaging of surrounding pixels in the same frame

3) averaging of surrounding pixels in the previous (backward look-up) frame.

4) averaging of surrounding pixels in the next (forward look-up) frame.

5) averaging of surrounding pixels in the same frame and/or previous frame, and/or next frame.

And a combination of any or all of the above methods.

Finally, any loss of pixel packets is recovered or mitigated by replacing the pixel of a frame with the corresponding pixel in the previous or next frame; replacing a pixel of a frame with the average of the corresponding pixels from previous and next frame; replacing a pixel of a frame with the average of the pixels surrounding the corresponding pixel from previous frame and the corresponding pixel from the next frame; replacing a pixel of a frame from the average of the pixels surrounding the corresponding pixel from next frame and the corresponding pixel from the previous frame.

And in all of the methods above, the next frame may be replaced by a group of next frames and the previous frames may be a group of previous frames. In the above, “average” may refer to simple average, mean, median, a weighted average, a weighted mean or a weighted median based on a configurable or a pre-set parameter.

For packet insertion, the estimated pixel or a group of pixels are recoded into packets and inserted in the packet stream for further transmission.

For pixel insertion, after the estimated pixel or a group of pixels are inserted into the frame, they are forwarded to the display unit.

In one embodiment, the transmitting processes and interfaces are implemented in a conventional programming language, such as C or C++ or another suitable programming language. In one embodiment of the invention, the program is stored on a computer accessible storage medium at a Picon transmitter which is a part of or attached to a station, for example, devices as shown in FIG. 1. In another embodiment, the program can be stored in other system locations. The storage medium may comprise any of a variety of technologies for storing information. In one embodiment, the storage medium comprises a random access memory (RAM), hard disks, floppy disks, digital video devices, compact discs, video discs, and/or other optical storage mediums, etc.

The processor may have a configuration based on Intel Corporation's family of microprocessors, such as the Pentium family and Microsoft Corporation's Windows operating systems such as Windows 95, Windows 98, Windows 2000 or Windows NT.

In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 2000/9×/ME/XP, Macintosh OS, OS/2 and the like. In another embodiment, the configurable interface can be implemented with embedded software.

In one embodiment of the invention, the program is stored on a computer accessible storage medium at a transmitter which is a part of or attached to a station, for example, a device coordinator or devices as shown in FIG. 1. In another embodiment, the program can be stored in other system locations so long as it can perform the transmitting procedure according to embodiments of the invention. The storage medium may comprise any of a variety of technologies for storing information. In one embodiment, the storage medium comprises a random access memory (RAM), hard disks, floppy disks, digital video devices, compact discs, video discs, and/or other optical storage mediums, etc.

In another embodiment, at least one of the device coordinator and devices comprises a processor configured to or programmed to perform the transmitting procedure. The program may be stored in the processor or a memory of the coordinator and/or the devices. In various embodiments, the processor may have a configuration based on Intel Corporation's family of microprocessors, such as the Pentium family and Microsoft Corporation's Windows operating systems such as Windows 95, Windows 98, Windows 2000 or Windows NT. In one embodiment, the processor is implemented with a variety of computer platforms using a single chip or multi-chip microprocessors, digital signal processors, embedded microprocessors, microcontrollers, etc. In another embodiment, the processor is implemented with a wide range of operating systems such as Unix, Linux, Microsoft DOS, Microsoft Windows 2000/9×/ME/XP, Macintosh OS, OS/2 and the like. In another embodiment, the transmitting procedure can be implemented with an embedded software. Depending on the embodiments, additional states may be added, others removed, or the order of the states changes.

According to various embodiments, there is provided: a method for transmission of a video data stream, comprising the steps of: tagging a data packet with a frame index and/or a packet index; receiving a series of said data packets; constructing frames using said received data packets; detecting which, if any, pixels are lacking data in a frame; and repeatedly producing an estimating data for respective missing pixels by using pixels spatially surrounding the missing pixels in the frame as inputs, while ignoring pixels which are missing data.

According to various embodiments, there is provided: a device for recovering missing pixel data, comprising: a memory device that stores a series of frame data; and a processing device that detects missing pixels in a current frame, identifies the corresponding pixels in the previous frame and in the next frame of said frame, and estimates the respective missing pixel by using surrounding pixels of the missing pixel in the same said frame, corresponding surrounding pixels in the previous frame and/or corresponding surrounding pixels in the next frame; wherein said processing device estimates the respective missing pixel by calculating weighted average, weighted mean and/or weighted median based on a configurable pre-set parameter; wherein said processing device estimates a respective missing pixel by averaging a selected group of pixels from a previous frame and/or a next frame; wherein said processing device further replaces the missing pixel with at least one estimated pixel value.

According to various embodiments, there is provided: a system for wireless multimedia transmission, comprising: a device that multiplexes a high data rate stream into plurality of specified low data rate streams of data packets; a device that tags said low data rate data packets with frame index and/or packet index; a transmitting device that wirelessly transmits said data packets via plurality of wireless channels; a receiving device that wirelessly receives said data packets; a processing device that constructs frames using received data packets and detects missing pixels in a frame of the wirelessly received data packets, identifies the corresponding pixels of the missing pixels in the previous frame and in the next frame of said frame, and estimates the respective missing pixel by using surrounding pixels of the missing pixel in the same said frame, corresponding surrounding pixels in the previous frame and/or corresponding surrounding pixels in the next frame, and inserts said estimated pixel into said frame; and a multiplexing device that assembles said data packets into specified formatted data stream; wherein said processing device estimates the respective missing pixel by calculating weighted average, weighted mean and/or weighted median based on a configurable pre-set parameter; wherein said processing device estimates a respective missing pixel by averaging a selected group of pixels from a previous frame and/or a next frame; wherein said processing device further replaces the missing pixel with at least one estimated pixel value; wherein said data packets are IP data packets; wherein said data packets complies with IEEE 802.11n.

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

In video multicast/broadcast over IP-based wireless networks, video data is encapsulated in UDP/IP packets and multicast/broadcast to the mobile devices over wireless networks. The IP-based wireless networks can be wireless local area networks (WLANs), cellular networks, wireless metropolitan area networks (WMANs) and wireless regional area networks (WRANs).

A broadcast signal is transmitted to all possible receivers. A multicast signal is transmitted to a selected subset (one or more) of all possible receivers in a group simultaneously. As used herein multicast also includes broadcast. That is, a multicast signal may be transmitted to a selected subset of all possible receivers in a group where the selected subset may include the entire set of all possible receivers, i.e. the multicast group is all receivers.

“Average” in the above text may refer to simple average, mean, median, a weighted average, a weighted mean or a weighted median based on a configurable or a pre-set parameter. And the previous frame may also mean a group of previous frames and the next frame may mean a group of next frames.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method for transmission of a video data stream, comprising the steps of:
tagging a data packet with a frame index and/or a packet index;
receiving a series of said data packets;
constructing frames using said received data packets;
detecting which, if any, pixels are lacking data in a frame; and
repeatedly producing an estimating data for respective missing pixels by using pixels spatially surrounding the missing pixels in the frame as inputs, while ignoring pixels which are missing data.

2. The method of claim 1, wherein said received data packets are for a configurable number of past frames of said frame and for a configurable number of next frames of said frame.

3. The method of claim 1, wherein said received data packets are stored in a buffer.

4. The method of claim 1, wherein the step of detecting pixels lacking data is by identifying missing packets either in a frame index or in packet index.

5. The method of claim 1, wherein the step of producing an estimating data for a missing pixel is by averaging the pixel values surrounding the missing pixel in said frame.

6. The method of claim 1, wherein the step of producing an estimating data for a missing pixel is by averaging the corresponding pixel values in a previous frame and in a next frame.

7. The method of claim 1, wherein the step of producing an estimating data for a missing pixel is by averaging the pixel values surrounding the corresponding missing pixel in a previous frame.

8. The method of claim 1, wherein the step of producing an estimating data for a missing pixel is by averaging the pixel values surrounding the corresponding missing pixel in a next frame.

9. The method of claim 1, wherein the step of producing an estimating data for a missing pixel is by averaging the pixel values surrounding the corresponding missing pixel in a next frame and in a previous frame.

10. The method of claim 1, wherein the step of producing an estimating data for a missing pixel is by averaging the pixel values surrounding the corresponding missing pixel in a next frame and in a previous frame and in said current frame.

11. The method of claim 1, wherein the step of producing an estimating data for a missing pixel is by replacing the missing pixel with the corresponding pixel in a next frame or in a previous frame.

12. The method of claim 1, wherein the step of repeatedly producing an estimating data for respective missing pixels is by estimating first the outer-most pixel.

13. The method of claim 1, wherein the step of repeatedly producing an estimating data for respective missing pixels is by estimating first the pixel that is least missing in a series of frames.

14. The method of claim 1, wherein the step of producing an estimating data for a missing pixel is by calculating weighted average, weighted mean and/or weighted median based on a configurable pre-set parameter.

15. A method for estimating lost information of a video data transmission, comprising the steps of:
receiving a series of data packets tagged with a frame index and/or a packet index;
constructing frames using received said data packets;
detecting missing data packets by using said packet index;
identifying the missing pixels in a frame by using said frame index and/or packet index;
estimating the missing pixels; and
inserting the estimated pixels into the corresponding frames.

16. The method of claim 15, further comprising the step of:
storing plurality of frames spatially adjacent to the current frame in memory.

17. The method of claim 16, wherein the step of estimating comprises:
first estimating the missing pixel that is in a frame containing least missing pixels.

18. The method of claim 15, wherein the step of estimating comprises:
identifying the corresponding pixels of a particular missing pixel in the previous frame and the next frame; and
averaging said corresponding pixels of both frames.

19-22. (canceled)

23. A device for recovering missing pixel data, comprising:
a memory device that stores a series of frame data; and
a processing device that detects missing pixels in a current frame, identifies the corresponding pixels in the previous frame and in the next frame of said frame, and estimates the respective missing pixel by using surrounding pixels of the missing pixel in the same said frame, corresponding surrounding pixels in the previous frame and/or corresponding surrounding pixels in the next frame.

24. The device of claim 23, wherein said processing device estimates the respective missing pixel by calculating weighted average, weighted mean and/or weighted median based on a configurable pre-set parameter.

25-49. (canceled)
